(19) United States
(12) Patent Application Publication
(10) Pub. No.: US 2015/0234938 A1
(43) Pub. Date: Aug. 20, 2015

(54) METHOD AND ELECTRONIC TERMINAL FOR SEARCHING FOR CONTACT IN DIRECTORY

(71) Applicant: Tencent Technology (Shenzhen) Company Limited, Shenzhen (CN)

(72) Inventors: Xinxin ZHANG, Shenzhen (CN); Jiayao FENG, Shenzhen (CN); Fangmin LlU, Shenzhen (CN)

(21) Appl. No.: 14/702,328

(22) Filed: May 1, 2015

Related U.S. Application Data
(63) Continuation of application No. PCT/CN2013/083939, filed on Sep. 22, 2013.

(30) Foreign Application Priority Data
Nov. 6, 2012 (CN) 201210438293.2

(51) Int. Cl. G06F 17/30

(52) U.S. Cl. CPC G06F 17/30988; G06F 17/30554

(57) ABSTRACT

The present disclosure discloses a method for searching for a contact in a list of contact entries performed at a computing device, the method including: displaying a list of contact entries in a first display area; displaying a list of top-level indexes in a second display area; when a first target index is selected, locating a sub-list of contact entries matching the first target index and displaying them in the first display area in an order defined by the first target index; obtaining a list of sub-level indexes through aggregation; displaying the list of sub-level indexes in a third display area; and when a second target index in the list of sub-level indexes is selected, locating a sub-list of contact entries matching the second target index and displaying them in the first display area in an order defined by the second target index.

### RELATED APPLICATION

This patent application is a continuation application of PCT Patent Application No. PCT/CN2013/083939, entitled “METHOD AND ELECTRONIC TERMINAL FOR SEARCHING FOR CONTACT IN DIRECTORY” filed on Sep. 22, 2013, which claims priority to Chinese Patent Application No. 201210438293.2, filed with the Chinese Patent Office on Nov. 6, 2012 and entitled “METHOD AND COMPUTING DEVICE FOR SEARCHING FOR CONTACT IN DIRECTORY”, both of which are incorporated herein by reference in their entirety.

### FIELD OF THE TECHNOLOGY

The present disclosure relates to the field of data information searches, and in particular, to a method and terminal for searching for a contact in a list of contact entries.

### BACKGROUND OF THE DISCLOSURE

With the rapid development of touchscreen technologies, touchscreens are used in most existing terminals, so as to bring brand new visual experience and using experience to a user. Most of the existing touchscreen terminals (such as touchscreen mobile phones, and tablet computers) provide a directory function to a user, so that the user can record and search for some necessary information anytime anywhere. For mobile phones of different manufacturers, contact entries are sorted, searched for, and switched in different manners. Generally, the contact entries are sorted from top to bottom according to a sequence of initials of the contact entries in the English alphabet and their input times; during a search, the screen is scrolled down from the first contact entry in the directory until a contact is found, or a contact is searched for according to some simple indexes in combination with a manner of screen scrolling; and the contact entries are switched in a manner of sequential sliding switching from top to bottom.

When there are many contact entries, to improve efficiency of searching for a contact, the following manners are used in the existing technology to search for a contact in a directory:

Method 1: A group in which an initial of a contact is located is found by means of screen scrolling, subsequently, the screen is scrolled down from the first contact entry in the found group to search for the contact, and during the search, groups are switched in a manner of sliding switching from top to bottom.

Method 2: An English name or Pinyin initials of each Chinese character of a Chinese name of a user is input by means of a virtual keyboard (or in a manner of hand writing), and subsequently, a name of the contact is retrieved in the directory by using an initial of the English letters or the Chinese Pinyin.

The inventors of the present disclosure find that:

(1) For Method 1 in the existing technology, when there are many contact entries in the group, it takes more time to search for the contact by scrolling down the screen, causing high time costs.

(2) For Method 2, for input by means of the virtual keyboard or hand writing, a possibility of wrong press or mistype exists, and when input error occurs, retyping or rewriting needs to be performed by pressing the backspace key, causing low efficiency.

### SUMMARY

To solve the problem of low efficiency of an existing method for searching for a contact in a list of contact entries, embodiments of the present disclosure provide a method and a computing device for searching for a contact in a list of contact entries. The technical solutions are as follows:

A method for searching for a contact in a list of contact entries performed at a computing device having a display includes: displaying at least a subset of a list of contact entries in a first display area of the display; displaying a list of top-level indexes of the list of contact entries in a second display area of the display adjacent the first display area; when it is detected that a first target index in the list of top-level indexes is selected, locating a sub-list of contact entries matching the first target index and displaying the sub-list of contact entries matching the first target index in the first display area in an order defined by the first target index; obtaining a list of sub-level indexes from the sub-list of contact entries through aggregation; displaying the list of sub-level indexes in a third display area of the display adjacent the second display area; and when it is detected that a second target index in the list of sub-level indexes is selected, locating a sub-list of contact entries matching the second target index and displaying the sub-list of contact entries matching the second target index in the first display area in an order defined by the second target index.

A computing device includes: a processor, a display, memory and one or more program modules stored in the memory and to be executed by the processor, including: a first display module, a first index processing module, and a second index processing module. The first display module is configured to configured to display at least a subset of a list of contact entries in a first display area of the display; the first index processing module includes: a first display unit, configured to display a list of top-level indexes of the list of contact entries in a second display area of the display adjacent the first display area; and a first retrieval unit, configured to, when it is detected that a first target index in the list of top-level indexes is selected, locate a sub-list of contact entries matching the first target index and display the sub-list of contact entries matching the first target index in the first display area in an order defined by the first target index; and the second index processing module includes: an aggregation unit, configured to obtain a list of sub-level indexes from the sub-list of contact entries through aggregation; a second display unit, configured to display the list of sub-level indexes in a third display area of the display adjacent the second display area; and a second retrieval unit, configured to, when it is detected that a second target index in the list of sub-level indexes is selected, locating a sub-list of contact entries matching the second target index and displaying the sub-list of contact entries matching the second target index in the first display area in an order defined by the second target index.

A non-transitory computer readable medium storing one or more program modules, wherein the one or more program modules, when executed by a computing device having a processor and a display, cause the computing device to perform one or more operations including: displaying at least a subset of a list of contact entries in a first display area of the display; displaying a list of top-level indexes of the list of contact entries in a second display area of the display adjacent the first display area; when it is detected that a first target index in the list of top-level indexes is selected, locating a sub-list of contact entries matching the first target index and displaying the sub-list of contact entries matching the first target index in the first display area in an order defined by the first target index; obtaining a list of sub-level indexes from the sub-list of contact entries through aggregation; displaying the list of sub-level indexes in a third display area of the display adjacent the second display area; and when it is detected that a second target index in the list of sub-level indexes is selected, locating a sub-list of contact entries matching the second target index and displaying the sub-list of contact entries matching the second target index in the first display area in an order defined by the second target index.

A method for retrieving a contact includes: receiving, from a user, an input corresponding to a first target index, the first target index being included in a list of top-level indexes; acquiring a list of sub-level indexes corresponding to the first target index; displaying the list of sub-level indexes; receiving, from the user, an input corresponding to a second target index, the second target index being included in the list of sub-level indexes; and acquiring and displaying a list of contact entries that correspond to the second target index.

A computing device includes an interactive apparatus and a processor. The interactive apparatus is configured to receive, from a user, an input corresponding to a first target index and an input corresponding to a second target index, and configured to display a list of sub-level indexes corresponding to the first target index and a list of contact entries that correspond to the second target index, the first target index being included in a list of top-level indexes and the second target index being included in the list of sub-level indexes. The processor is configured to acquire the list of sub-level indexes and the list of contact entries.

Compared with the existing technology, in the embodiments of the present disclosure, a contact is retrieved according to first-level and sub-level indexes, which is simple and quick in operation, greatly improves efficiency of a search in a directory, and makes user communication smoother.

### BRIEF DESCRIPTION OF THE DRAWINGS

To describe the technical solutions in the embodiments of the present disclosure more clearly, the following briefly introduces the accompanying drawings used in the embodiments. Apparently, the accompanying drawings listed below only show some embodiments of the present disclosure, and a person of ordinary skill in the art may still derive other drawings from these accompanying drawings without creative efforts.

FIG. 1 is a flowchart of a method for searching for a contact in a list of contact entries according to some embodiments of the present disclosure;

FIG. 2 is a schematic display diagram of a list of contact entries and a list of top-level indexes according to some embodiments of the present disclosure;

FIG. 3 is a schematic diagram of a simultaneous display of top-level indexes and sub-level indexes according to some embodiments of the present disclosure;

FIG. 4 is a schematic diagram showing that sub-level indexes is selected according to some embodiments of the present disclosure;

FIG. 5 is a schematic diagram of locating a contact entry according to sub-level indexes according to some embodiments of the present disclosure;

FIG. 6 is a structural block diagram of a computing device according to Embodiment 2 of the present disclosure;

FIG. 7 is a flowchart of a method for retrieving a contact according to an embodiment of the present disclosure; and

FIG. 8 is a schematic block diagram of a computing device according to an embodiment of the present disclosure.

### DESCRIPTION OF EMBODIMENTS

The following clearly and completely describes the technical solutions in the present disclosure with reference to the accompanying drawings in the present disclosure. Apparently, the described embodiments are some rather than all of the embodiments of the present disclosure. All other embodiments obtained by a person of ordinary skill in the art based on the embodiments of the present disclosure without creative efforts shall fall within the protection scope of the present disclosure.

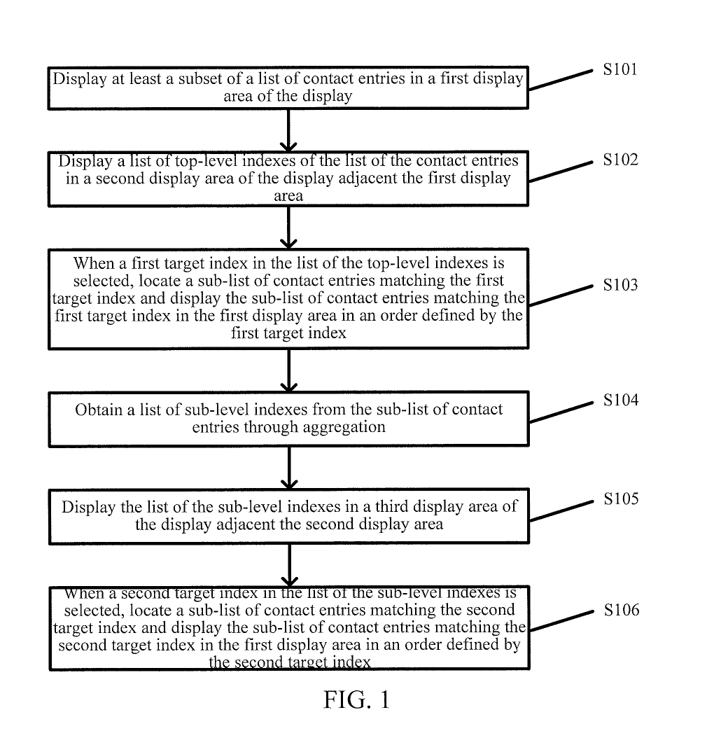

Referring to FIG. 1, a method for searching for a contact in a list of contact entries is disclosed. The method is executed by a computing device that supports a touch control operation, such as a touchscreen mobile phone or tablet computer. The foregoing method includes the following steps:

Step 101: Display at least a subset of a list of contact entries in a first display area of the display.

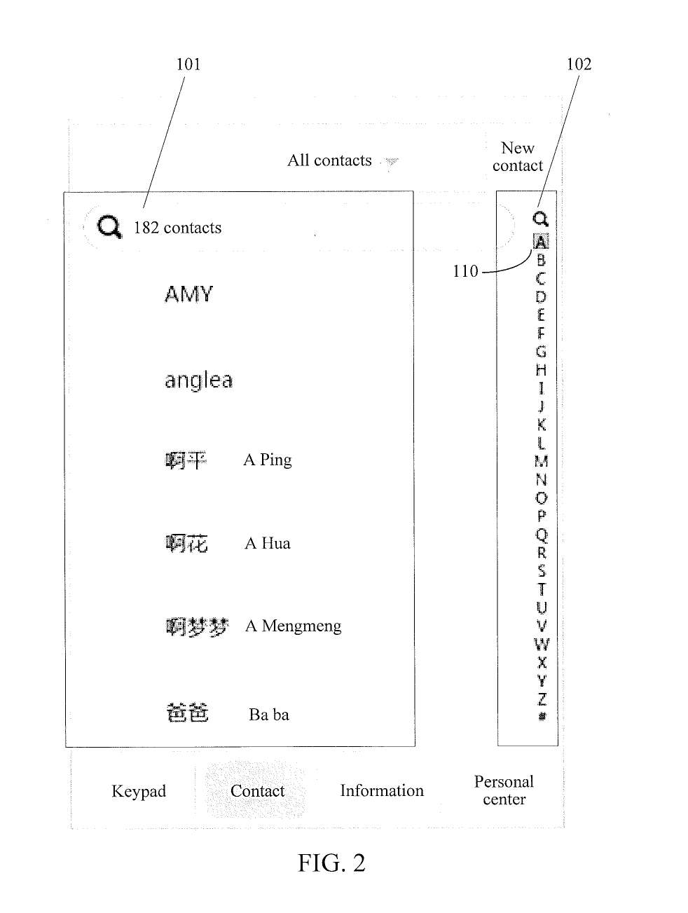

FIG. 2 is a schematic diagram of a contact interface of a computing device. The foregoing contact interface includes a first display area 101 and a second display area 102. The first display area 101 is used to display a list of contact entries.

Generally, a contact entry includes content such as a name, a contact method and/or remark information, where the name is used to mark the contact entry, which may be a name of a contact, some other customized names, or the like, and the name may be a Chinese name, an English name, some nicknames, or the like; the contact method includes content such as a telephone number, a mailing address or/and an Email; and the remark information may be content such as some calendar reminders or personal account information. The contact entry is input by a user to a touchscreen terminal and saved in a directory. It can be understood that for each entry in the directory, some fields of the entry, such as a name, may be displayed in the first display area 101 only.

Step 102: Display a list of top-level indexes of the list of contact entries in a second display area of the display adjacent the first display area.

As shown in FIG. 2, the list of top-level indexes may be, for example, English alphabets. The English alphabets may be all the 26 English letters, or may be obtained by aggregating first characters (for Chinese or other non-English characters, Pinyin or similar diacritical marks may be used) of all contact entries, and in this manner, index information whose retrieval result is null does not appear in the list of top-level indexes. Each piece of top-level indexes displayed in the second display area 102 can be selected independently. For example, the first top-level index “A” 110 is the default selected one when a user opens the list of contact entries for the first time.

Step 103: When it is detected that a first target index in the list of top-level indexes is selected, locate a sub-list of contact entries matching the first target index and display the sub-list of contact entries matching the first target index in the first display area in an order defined by the first target index.

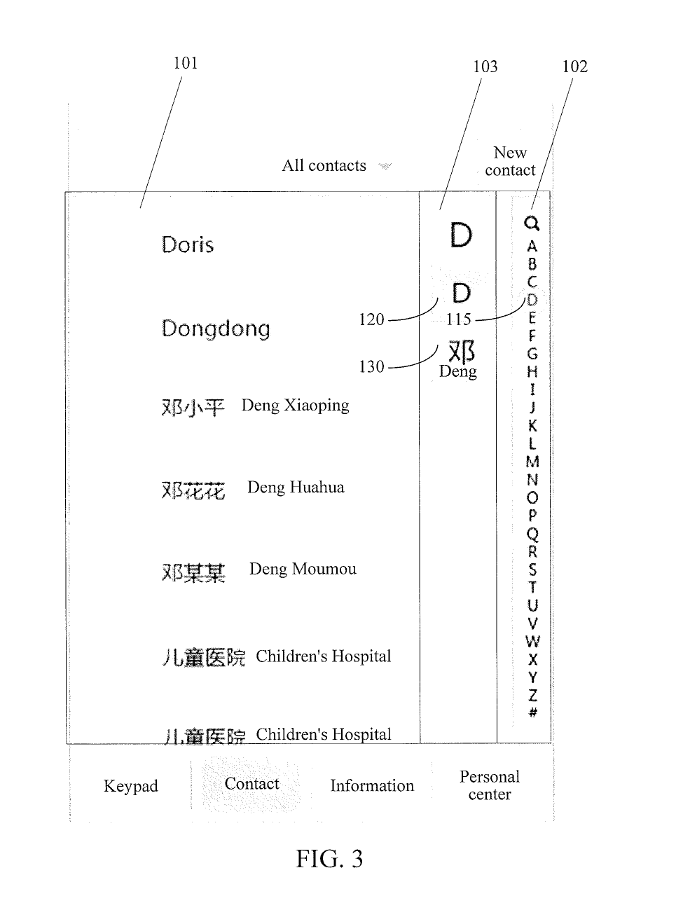

As shown in FIG. 2, a letter “A” in a current list of top-level indexes is selected in the second display area 102. It can be seen that all contact entries at a current location (which, for example, refers to a location closest to the top of the first display area 101) in the first display area 101 are contact entries beginning with the letter “A” or entries whose Pinyin begins with the letter “A”. As shown in FIG. 3, when a letter “D” 115 in the list of top-level indexes is selected in the second display area 102, it can be seen that all contact entries at a current location in the first display area 101 are contact entries beginning with the letter “D” or entries whose Pinyin begins with the letter “D”. In the manner shown in FIG. 2, only a locating operation is performed, that is, a currently displayed entry of the contact entries is identified to be the first entry matching the first target index. However, it can be understood that, in addition to the locating operation, a filter operation may also be performed, that is, after the first target index is selected, only a contact entry matching the first target index is displayed in the first display area 101.

In addition, not only the list of contact entries displayed in the first display area 101 is located, but also a contact entry matching the first target index is acquired. For example, in FIG. 3, when “D” in the list of top-level indexes is selected, the following 5 contact entries: Doris, Dongdong, Deng Xiaoping ( [symbol] ), Deng Huahua ( [symbol] ), and Deng Moumou ( [symbol] ), are acquired. The contact entries matching the first target index are sorted and displayed in the first display area in an order defined by the first target index “D” with English expressions ahead of Chinese expressions.

Step 104: Obtain a list of sub-level indexes from the sub-list of contact entries through aggregation.

Specifically, a first character of each entry in the acquired entries is acquired first; an occurrence frequency of each first character is determined; then the first characters are sorted according to their respective occurrence frequencies; and the sorted first characters are displayed as the sub-level indexes. It should be noted that the first characters herein are no longer limited to English letters, but may include a Chinese character, a character of another language, and a special symbol.

For example, in the foregoing five acquired contact entries, two first characters: “D” and “ [symbol] (Deng)” are acquired, where “D” appears twice, and “ [symbol] (Deng)” appears 3 times. If sorting is performed according to occurrence frequencies, “ [symbol] (Deng)” may rank before “D”. However, it may also be set such that an English character ranks before a Chinese character, and in this case, the sorting shown in FIG. 3 may appear. It can be understood that a specific sorting rule may be arbitrarily formulated without any limitation.

Step 105: Display the list of sub-level indexes in a third display area of the display adjacent the second display area.

As shown in FIG. 3, a list of sub-level indexes, e.g., “D” 120 and “ [symbol] (Deng)” 130, obtained through aggregation in step S104 is displayed in a third display area 103. Similar to the list of top-level indexes in the second display area 102, each index in the list of sub-level indexes may also be selected independently.

The third display area 103 is located between the first display area 101 and the second display area 102. It can be understood that to make full use of display space of a screen, the third display area 103 may be separately allocated when display is required. For example, when the list of sub-level indexes does not need to be displayed, a width of the third display area 103 may be set to zero, and the saved display space may be provided for the first display area 101 for use. However, when the list of sub-level indexes needs to be displayed, a width of the first display area 101 is reduced, and the width of the third display area 103 is set to a suitable non-zero value for displaying the list of sub-level indexes corresponding to the contact entries currently in the first display area 101.

Step 106: When it is detected that a second target index in the list of sub-level indexes is selected, locate a sub-list of contact entries matching the second target index and display the sub-list of contact entries matching the second target index in the first display area in an order defined by the second target index.

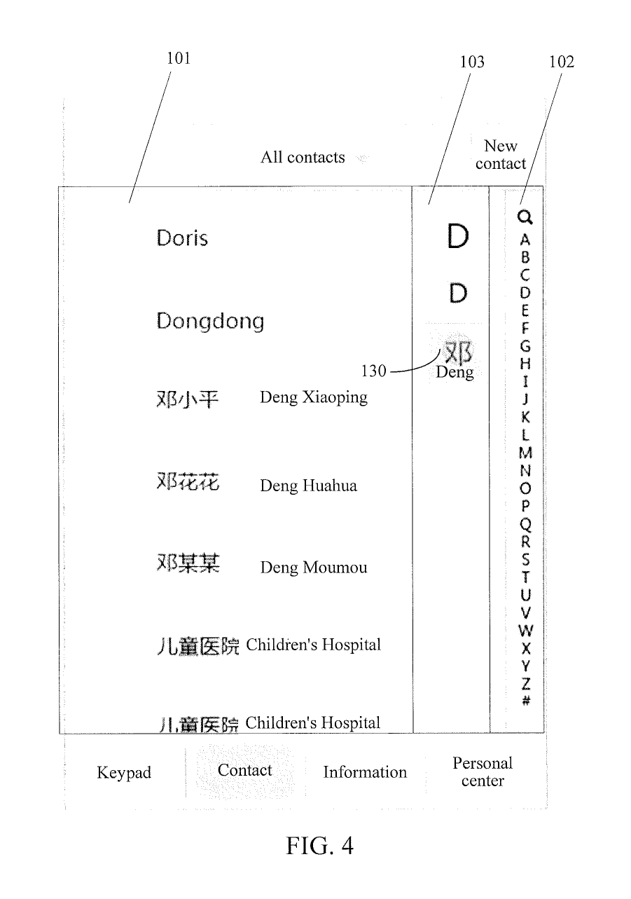

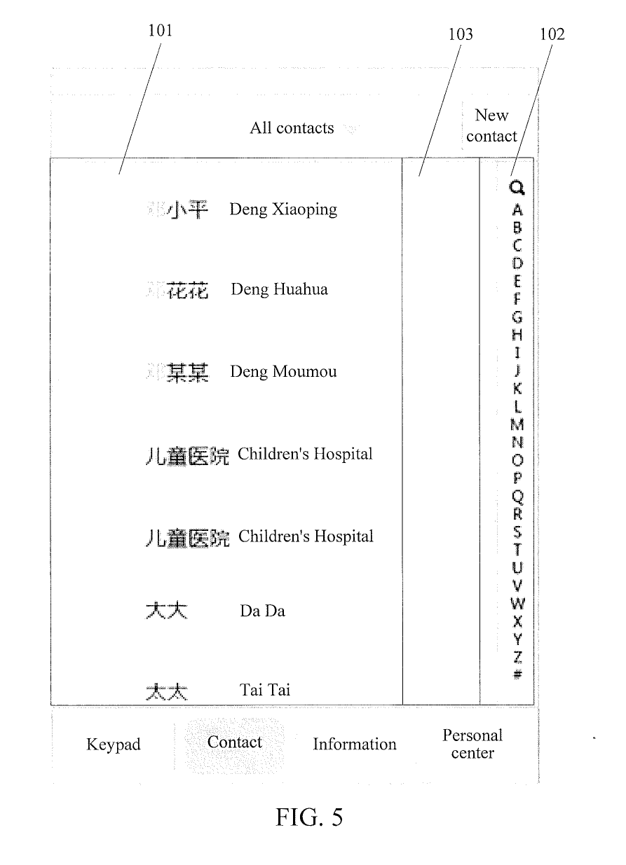

Referring to both FIG. 4 and FIG. 5, in a status shown in FIG. 4, a second target index 130 “ [symbol] (Deng)” is selected, and in this case, the selected second target index is highlighted, for example, the selected second target index is changed to a brighter color, a bright background color is added, a frame is displayed, or the like. In addition, the five acquired contact entries in step S103 are located.

In a manner shown in FIG. 5, only a locating operation is performed, that is, a currently displayed entry of the contact entries is identified to be the first entry matching the second target index. It can be seen that another contact entry, such as “ [symbol] (Children's Hospital)”, is also displayed in the first display area 101. However, it can be understood that, in addition to the locating operation, a filter operation may also be performed, that is, after the second target index is selected, only a contact entry matching the second target index is displayed in the first display area 101. In this case, the first display area 101 only includes three entries: Deng Xiaoping ( [symbol] [symbol] ), Deng Huahua ( [symbol] ), and Deng Moumou ( [symbol] ).

Generally, when a user locates a contact entry by selecting a second target index, it may be construed as a completion of a contact entry retrieval operation. In this case, the third display area 103 may be hidden to make the display interface simpler. When the user selects another target index in the list of top-level indexes or sub-level indexes, the third display area 103 may be redisplayed.

However, it can be understood that a possible misoperation exists in use, for example, in the status shown in FIG. 4, the user may want to select “ [symbol] (Deng)” but selects “D” wrongly. But as described above, in this case, the third display area 103 may be hidden already. To solve this problem, a predetermined user operation may be monitored. For example, a specific user gesture is monitored, and when the user gesture is detected, the third display area 103 is redisplayed. For example, for the contact interface, a gesture of swiping left or right is deemed to be an invalid operation. Therefore, the gesture of swiping left or right may be monitored. For example, when a gesture of swiping left is detected (the third display area 103 is located on the left of the second display area 102), the list of sub-level indexes located at the third display area 103 is redisplayed.

In this embodiment of the present disclosure, a contact is retrieved according to first-level and sub-level indexes, which is simple and quick in operation, greatly improves efficiency of a search in a directory, makes user communication smoother, and in particular, is applicable to a country or district in which a non-letter language is used.

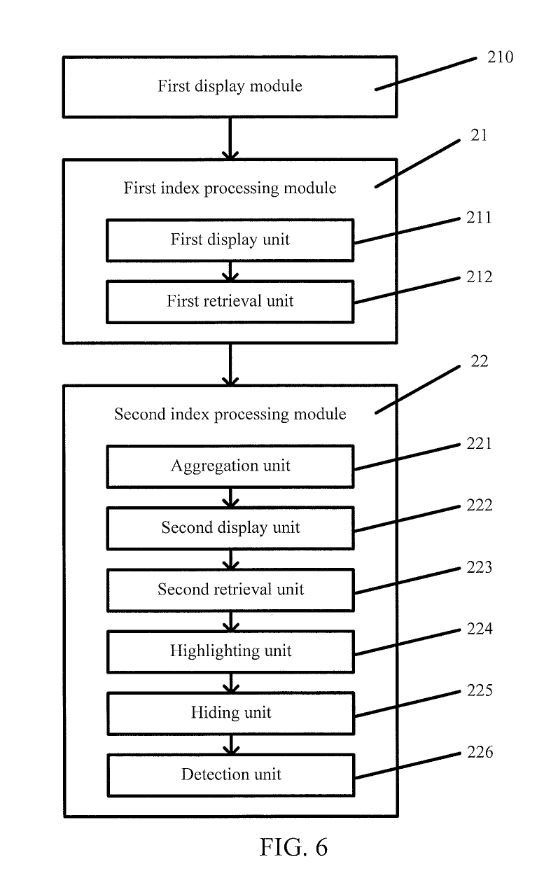

Referring to FIG. 6, the second embodiment provides a computing device. The computing device typically includes one or more processors, one or more network interfaces, memory, and one or more communication buses for interconnecting these components (sometimes called a chipset). The computing device also includes a user interface that enables presentation of media content, including one or more speakers and/or one or more visual displays (e.g., a touch screen). The user interface also includes one or more input devices, including user interface components that facilitate user input such as a keyboard, a mouse, a voice-command input unit or microphone, a touch sensitive display (e.g., a touch screen), a touch-sensitive input pad, a gesture capturing camera, or other input buttons or controls. Memory includes high-speed random access memory, such as DRAM, SRAM, DDR RAM, or other random access solid state memory devices; and, optionally, includes non-volatile memory, such as one or more magnetic disk storage devices, optical disk storage devices, flash memory devices, or other non-volatile solid state storage devices. Memory, optionally, includes one or more storage devices remotely located from the processor. Memory, or alternately the non-volatile memory device(s) within the memory, includes a non-transitory computer readable storage medium. In some embodiments, the memory, or the non-transitory computer readable storage medium of memory, stores the following programs, modules, and data structures, or a subset or superset thereof. In some embodiments, the computing device includes a first display module 210, a first index processing module 21, and a second index processing module 22.

The first display module 210 is configured to display at least a subset of a list of contact entries in a first display area of the display.

The first index processing module 21 includes: a first display unit 211 and a first retrieval unit 212. The first display unit 211 is configured to display a list of top-level indexes of the list of contact entries in a second display area of the display adjacent the first display area; and the first retrieval unit 212 is configured to, when it is detected that a first target index in the list of top-level indexes is selected, locate a sub-list of contact entries matching the first target index and display the sub-list of contact entries matching the first target index in the first display area in an order defined by the first target index.

The second index processing module 22 includes: an aggregation unit 221, a second display unit 222, and a second retrieval unit 223. The aggregation unit 221 is configured to obtain a list of sub-level indexes from the sub-list of contact entries through aggregation; the second display unit 222 is configured to display the list of sub-level indexes in a third display area of the display adjacent the second display area; and the second retrieval unit 223 is configured to, when it is detected that a second target index in the list of sub-level indexes is selected, locating a sub-list of contact entries matching the second target index and displaying the sub-list of contact entries matching the second target index in the first display area in an order defined by the second target index.

The aggregation unit 221 is configured to: acquire a first character of each contact entry matching the first target index; determine an occurrence frequency of each first character; sort the first characters according to the occurrence frequencies; and select the sorted first characters as the list of sub-level indexes.

The second index processing module 22 further includes a highlighting unit 224, configured to highlight one or more contact entries matching the second target index in the first display area when it is detected that the second target index in the list of sub-level indexes is selected.

The second index processing module 22 further includes a hiding unit 225, configured to hide the list of sub-level indexes from the third display area after locating the sub-list of contact entries matching the second target index.

The second index processing module 22 further includes a detection unit 226, configured to redisplay the list of sub-level indexes in the third display area when a user selection of the third display area is detected.

For further details of the computing device, reference may further be made to FIG. 1 to FIG. 5 and related descriptions.

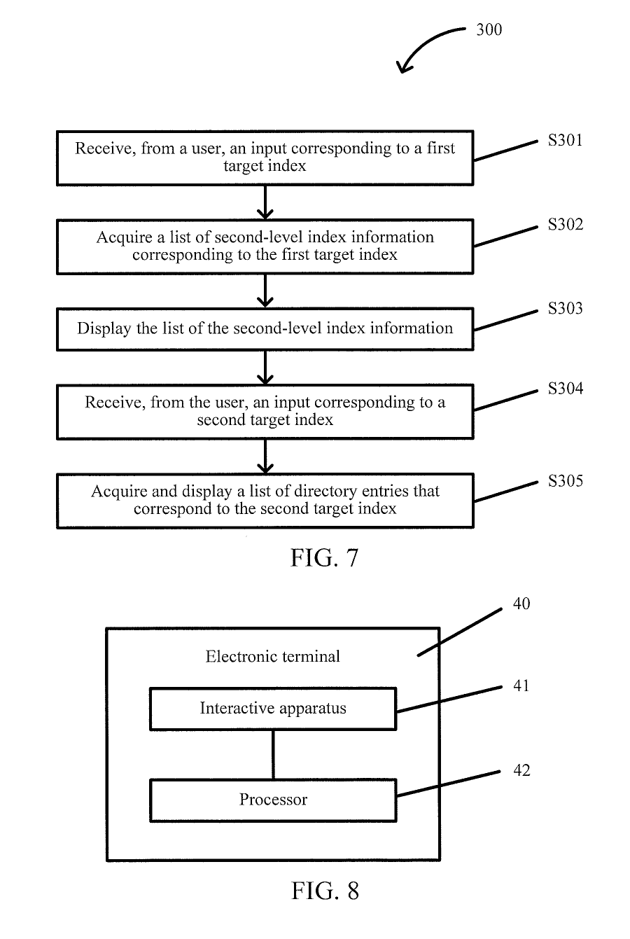

A method for retrieving a contact is provided. FIG. 7 is a flowchart of a method 300 for retrieving a contact according to an embodiment of the present disclosure. The method is described below with reference to FIG. 7.

Step S301: Receive, from a user, an input corresponding to a first target index. The first target index is included in a list of top-level indexes. The list of top-level indexes is already described in the foregoing embodiment, and details are not described herein again. The first target index may be an English letter. For example, the list of top-level indexes may be a list formed by the 26 English letters, and the first target index may be any one of the 26 English letters. In an embodiment, the first target index may be directly input by a user by using a keyboard. For example, when the user needs to search for a contact that includes a word or Pinyin beginning with a letter “A”, the user may directly input the letter “A” by using the keyboard. In another embodiment, the list of top-level indexes is first displayed, and then the user selects the first target index by using a touchscreen. For example, when a user needs to search for a contact that includes a word or Pinyin beginning with a letter “A”, a list formed by the 26 English letters are first displayed, and then the user selects the letter “A” by using a touchscreen. It is more convenient and quick to select the first target index by using a touchscreen. A person skilled in the art should understand that the foregoing displaying the list of top-level indexes may be displaying at least a part of the list of top-level indexes. For example, when the list of top-level indexes exceeds a display range of a display screen, only a part of the list of top-level indexes may be displayed. Subsequently, other parts of the list of top-level indexes may be displayed in a page flipping manner such as screen scrolling.

Step S302: Acquire a list of sub-level indexes corresponding to the first target index. The list of sub-level indexes may include a first character of each of all contact entries that correspond to the first target index. Referring to FIG. 3 again, when the first target index is a letter “D”, all contact entries corresponding to the letter “D” are “Doris”, “Dongdong”, “Deng Xiaoping ( [symbol] )”, “Deng Huahua ( [symbol] )”, and “Deng Moumou ( [symbol] )”. First characters of the foregoing five contact entries include two “D”s and three “ [symbol] (Deng)”s. “D” and “ [symbol] (Deng)” may be used as two indexes in the list of sub-level indexes. A list formed by “D” and “ [symbol] (Deng)” is the list of sub-level indexes. A person skilled in the art can understand that the list of sub-level indexes may include characters at other locations of each of all the contact entries that correspond to the first target index, for example, all characters of the last word of each contact entry. This helps to retrieve a contact who has an English name. The list of sub-level indexes may be generated when the user inputs a new contact entry or may be generated after an input corresponding to the first target index is received from the user.

Step S303: Display the list of sub-level indexes. A person skilled in the art should understand that each index in the list of sub-level indexes may be displayed in an arbitrary order. For example, an English index may rank before a Chinese index in list of sub-level indexes, and/or Chinese indexes may be sorted based on strokes or in an order of Pinyin of the Chinese indexes in a Chinese Pinyin table. For example, when a list of sub-level indexes that includes “ [symbol] ”, “ [symbol] ”, and “ [symbol] ” is displayed, sorting may be performed based on strokes of each Chinese character, that is, “ [symbol] ”, “ [symbol] ”, and “ [symbol] ” are sequentially displayed. Sorting may also be performed in an order of Pinyin of each Chinese character in the Chinese Pinyin table, that is, “Li”, “Lin”, and “Liu” are sequentially displayed. A person skilled in the art should understand that the foregoing displaying the list of sub-level indexes may be displaying at least a part of the list of sub-level indexes. For example, when the list of sub-level indexes exceeds a display range of a display screen, only a part of the list of sub-level indexes may be displayed. Subsequently, other parts of the list of sub-level indexes may be displayed in a page flipping manner such as screen scrolling.

In an embodiment, before the list of sub-level indexes is displayed, the method 300 further includes the following step: collecting statistics on an occurrence frequency, in all the contact entries that correspond to the first target index, of each index in the list of sub-level indexes. The displaying the list of sub-level indexes may include: sequentially displaying each index in the list of sub-level indexes according to the occurrence frequency. Referring to FIG. 3 again, when the first target index is a letter “D”, all contact entries corresponding to the letter “D” are “Doris”, Deng “Xiaoping ( [symbol] )”, “Deng Huahua ( [symbol] )”, and “Deng Moumou ( [symbol] )”. The list of sub-level indexes includes two indexes “D” and “Deng”. An occurrence frequency of “D” is twice, and an occurrence frequency of “ [symbol] (Deng)” is three times. Therefore, the list of sub-level indexes may be displayed in the following order: “ [symbol] (Deng)” and “D”. The displaying the list of sub-level indexes may include: displaying an identifier corresponding to each index in the list of sub-level indexes. For example, a number may be allocated to each index, and the number is an identifier. Each index and the identifier corresponding thereto are displayed together. The user can select a second target index by inputting an identifier.

Step S304: Receive, from the user, an input corresponding to a second target index. The second target index is included in the list of sub-level indexes. Similar to the first target index, the second target index may be directly input by the user by using a keyboard or the second target index may be selected from the list of sub-level indexes by using a touchscreen. The second target index may include a Chinese character. The second target index may be, for example, a Chinese character, an English letter, or another symbol. Referring to FIG. 4 again, the second target index is “ [symbol] (Deng)”, and the user may select “ [symbol] (Deng)” by using the touchscreen.

Step S305: Acquire and display a list of contact entries that correspond to the second target index. The list of contact entries that correspond to the second target index may be generated when a user inputs a new contact entry or may be generated after an input corresponding to a second target index is received from the user. Referring to FIG. 4 and FIG. 5 again, when the user selects “ [symbol] (Deng)”, all contact entries corresponding to “ [symbol] (Deng)”, that is, “Xiaoping ( [symbol] [symbol] )”, “Deng Huahua ( [symbol] )”, and “Deng Moumou ( [symbol] )” are acquired. Subsequently, the three contact entries are displayed. A person skilled in the art should understand that the foregoing displaying a list of contact entries may be displaying at least one part of the list of contact entries. For example, when the list of contact entries exceeds a display range of a display screen, only a part of the list of contact entries may be displayed. Subsequently, other parts of the list of list of contact entries may be displayed in a page flipping manner such as screen scrolling.

In an embodiment, the displaying a list of contact entries that correspond to the second target index includes: highlighting a part, corresponding to the second target index, of each contact entry in the list of contact entries. Referring to FIG. 5, “ [symbol] (Deng)”s in the three contact entries “Xiaoping ( [symbol] )”, “Deng Huahua ( [symbol] )”, and “Deng Moumou ( [symbol] )” are highlighted. Highlighting may include modifying a font color to a bright color, adding a bright background color, adding a frame, or the like. Highlighting helps the user identify a contact that needs to be searched for, improving operation experience of the user.

In an embodiment, the method 300 further includes: hiding the list of sub-level indexes after the input corresponding to the second target index is received from the user. Hiding the list of sub-level indexes can make a display interface simpler and make it convenient for a user to view required information.

In an embodiment, the method 300 further includes the following steps: receiving, after the list of sub-level indexes is hidden, a display instruction input by the user; and redisplaying the list of sub-level indexes according to the display instruction. The user can input the display instruction by using a keyboard or a touchscreen. For example, a specific character may be input or a backspace key may be pressed by using a keyboard, or the like, or a specific gesture, such as a gesture of swiping left may be input by using a touchscreen. The redisplaying the list of sub-level indexes can enable the second target index to be re-input when a misoperation occurs, and therefore can better meet a requirement of the user.

In an embodiment, after the receiving, from the user, an input corresponding to the first target index, the method 300 further includes: displaying all contact entries that correspond to the first target index. For example, referring to FIG. 3, when the user selects the letter “D”, all contact entries corresponding to the letter “D”, that is, “Doris”, “Xiaoping ( [symbol] )”, “Deng Huahua ( [symbol] )”, and “Deng Moumou ( [symbol] )”, are displayed.

In an embodiment, the method 300 further includes: displaying the list of top-level indexes after the input corresponding to the first target index is received from the user. For example, before the input corresponding to the first target index is received from the user, a list formed by the 26 English letters may be first displayed. The user can select, in the list, a letter that needs to be searched for. Displaying the list of top-level indexes can improve operation experience of the user, and is more convenient and quick.

In an embodiment, before the receiving, from the user, the input corresponding to the first target index, the method 300 further includes: displaying original contact entries. The original contact entries refer to all input and stored contact entries.

According to the method for retrieving a contact provided by the present disclosure, a list of top-level indexes and a list of sub-level indexes are used to retrieve a contact, which is simple and quick in operation. The method improves efficiency of searching for a contact in a list of contact entries, and makes communication between a user and a terminal smoother.

### Embodiment 4

A computing device is provided. FIG. 8 is a schematic block diagram of a computing device 40 according to an embodiment of the present disclosure. As shown in FIG. 8, the computing device 40 includes an interactive apparatus 41 and a processor 42. The interactive apparatus 41 is configured to receive, from a user, an input corresponding to a first target index and an input corresponding to a second target index, and configured to display a list of sub-level indexes corresponding to the first target index and a list of contact entries that correspond to the second target index. The first target index is included in a list of top-level indexes and the second target index is included in the list of sub-level indexes. The processor 42 is configured to acquire the list of sub-level indexes and the list of contact entries. In an example, the interactive apparatus 41 may include a keyboard and a display screen, where the keyboard is used to receive an input of a user, and the display screen is used to display the input of the user. In another example, the interactive apparatus 41 may be a touchscreen, where the touchscreen may be used to both receive and display an input of a user.

A person of ordinary skill in the art can understand that the foregoing interactive apparatus and processor may further be configured to implement additional steps of the corresponding methods above. For brevity, additional functions of the interactive apparatus and the processor are not further described herein.

In an embodiment, the present disclosure provides a non-transient computer program product that includes executable program code for retrieving a contact. The executable program code may be used to: receive, from a user, an input corresponding to a first target index, where the first target index is included in a list of top-level indexes; acquire a list of sub-level indexes corresponding to the first target index; display the list of sub-level indexes; receive, from the user, an input corresponding to a second target index, where the second target index is included in the list of sub-level indexes; and acquire and display a list of contact entries that correspond to the second target index.

A person of ordinary skill in the art can understand that the foregoing executable program code may further be used to perform all steps of the corresponding methods above when executed by the processor. For brevity, additional functions of the executable program code are not further described herein. Note that the code can directly make the processor perform a specified operation, make the processor perform a specified operation after the code is compiled, and/or make the processor perform a specified operation in combination with other software, hardware, and/or firmware element (such as a library used to perform a standard function).

In this embodiment of the present disclosure, a contact is retrieved according to first-level and sub-level indexes, which is simple and quick in operation, greatly improves efficiency of a search in a directory, makes user communication smoother, and in particular, is applicable to a country or district in which a non-letter language is used.

Based on the foregoing descriptions of the implementation manners, a person skilled in the art may clearly understand that the methods of the foregoing embodiments may be implemented by software in addition to a necessary universal hardware platform or by hardware, but the former is a better implementation manner in most cases. Based on such an understanding, the technical solutions of the present disclosure essentially, or the part contributing to the existing technology may be implemented in a form of a software product. The computer software product is stored in a storage medium (such as a ROM/RAM, a magnetic disk, or an optical disc) and includes several instructions for instructing a computing device (which may be a mobile phone, a computer, a server, a network terminal, or the like) to perform the methods described in the embodiments of the present disclosure.

The foregoing descriptions are merely preferred implementation manners of the present disclosure. It should be noted that a person of ordinary skill in the art may further make some improvements and modifications without departing from the principles of the present disclosure, and these improvements and modifications should also be construed as falling within the protection scope of the present disclosure.

What is claimed is:

1. A method for searching for a contact in a list of contact entries, comprising:
at a computing device having a processor, memory for storing one or more program modules to be executed by the processor, and a display:
displaying at least a subset of a list of contact entries in a first display area of the display;
displaying a list of top-level indexes of the list of contact entries in a second display area of the display adjacent the first display area;
when it is detected that a first target index in the list of top-level indexes is selected, locating a sub-list of contact entries matching the first target index and displaying the sub-list of contact entries matching the first target index in the first display area in an order defined by the first target index;
obtaining a list of sub-level indexes from the sub-list of contact entries through aggregation;
displaying the list of sub-level indexes in a third display area of the display adjacent the second display area; and
when it is detected that a second target index in the list of sub-level indexes is selected, locating a sub-list of contact entries matching the second target index and displaying the sub-list of contact entries matching the second target index in the first display area in an order defined by the second target index.

2. The method according to claim 1, wherein the third display area is located between the first display area and the second display area.

3. The method according to claim 1, wherein the step of obtaining a list of sub-level indexes from the sub-list of contact entries through aggregation further comprises:
acquiring a first character of each contact entry matching the first target index;
determining an occurrence frequency of each first character;
sorting the first characters according to the occurrence frequencies; and
selecting the sorted first characters as the list of sub-level indexes.

4. The method according to claim 1, further comprising: highlighting one or more contact entries matching the second target index in the first display area when it is detected that the second target index in the list of sub-level indexes is selected.

5. The method according to claim 1, wherein the list of top-level indexes is English alphabets and the list of sub-level indexes comprises at least one Chinese character.

6. The method according to claim 1, further comprising: hiding the list of sub-level indexes from the third display area after locating the sub-list of contact entries matching the second target index.

7. The method according to claim 6, further comprising: redisplaying the list of sub-level indexes in the third display area when a user selection of the third display area is detected.

8. A computing device, comprising:
a processor;
a display;
memory; and
one or more program modules stored in the memory and to be executed by the processor, wherein the one or more program modules further include:
a first display module, configured to display at least a subset of a list of contact entries in a first display area of the display;
a first index processing module further including:
a first display unit, configured to display a list of top-level indexes of the list of contact entries in a second display area of the display adjacent the first display area;
a first retrieval unit, configured to, when it is detected that a first target index in the list of top-level indexes is selected, locate a sub-list of contact entries matching the first target index and display the sub-list of contact entries matching the first target index in the first display area in an order defined by the first target index; and
a second index processing module, further including:
an aggregation unit, configured to obtain a list of sub-level indexes from the sub-list of contact entries through aggregation;
a second display unit, configured to display the list of sub-level indexes in a third display area of the display adjacent the second display area; and
a second retrieval unit, configured to, when it is detected that a second target index in the list of sub-level indexes is selected, locating a sub-list of contact entries matching the second target index and displaying the sub-list of contact entries matching the second target index in the first display area in an order defined by the second target index.

9. The computing device according to claim 8, wherein the third display area is located between the first display area and the second display area.

10. The computing device according to claim 8, wherein the aggregation unit is configured to:
acquire a first character of each contact entry matching the first target index;
determine an occurrence frequency of each first character;
sort the first characters according to the occurrence frequencies; and
select the sorted first characters as the list of sub-level indexes.

11. The computing device according to claim 8, wherein the second index processing module further comprises a highlighting unit, configured to highlight one or more contact entries matching the second target index in the first display area when it is detected that the second target index in the list of sub-level indexes is selected.

12. The computing device according to claim 8, wherein the list of top-level indexes is English alphabets and the list of sub-level indexes comprises at least one Chinese character.

13. The computing device according to claim 8, wherein the second index processing module further comprises a hiding unit, configured to hide the list of sub-level indexes from the third display area after locating the sub-list of contact entries matching the second target index.

14. The computing device according to claim 13, wherein the second index processing module further comprises: a detection unit, configured to redisplay the list of sub-level indexes in the third display area when a user selection of the third display area is detected.

15. A non-transitory computer readable medium storing one or more program modules, wherein the one or more program modules, when executed by a computing device having a processor and a display, cause the computing device to perform one or more operations including:
displaying at least a subset of a list of contact entries in a first display area of the display;
displaying a list of top-level indexes of the list of contact entries in a second display area of the display adjacent the first display area;
when it is detected that a first target index in the list of top-level indexes is selected, locating a sub-list of contact entries matching the first target index and displaying the sub-list of contact entries matching the first target index in the first display area in an order defined by the first target index;
obtaining a list of sub-level indexes from the sub-list of contact entries through aggregation;
displaying the list of sub-level indexes in a third display area of the display adjacent the second display area; and
when it is detected that a second target index in the list of sub-level indexes is selected, locating a sub-list of contact entries matching the second target index and displaying the sub-list of contact entries matching the second target index in the first display area in an order defined by the second target index.

16. The non-transitory computer readable medium according to claim 15, wherein the third display area is located between the first display area and the second display area.

17. The non-transitory computer readable medium according to claim 15, wherein the operation of obtaining a list of sub-level indexes from the sub-list of contact entries through aggregation further comprises operations including:
acquiring a first character of each contact entry matching the first target index;
determining an occurrence frequency of each first character;
sorting the first characters according to the occurrence frequencies; and
selecting the sorted first characters as the list of sub-level indexes.

18. The non-transitory computer readable medium according to claim 15, wherein the one or more operations further include: highlighting one or more contact entries matching the second target index in the first display area when it is detected that the second target index in the list of sub-level indexes is selected.

19. The non-transitory computer readable medium according to claim 15, wherein the list of top-level indexes is English alphabets and the list of sub-level indexes comprises at least one Chinese character.

20. The non-transitory computer readable medium according to claim 15, wherein the one or more operations further include: hiding the list of sub-level indexes from the third display area after locating the sub-list of contact entries matching the second target index.
